(19) United States
(12) Patent Application Publication
(10) Pub. No.: US 2024/0212336 A1
(43) Pub. Date: Jun. 27, 2024

(54) SECURITY CHECK CT OBJECT RECOGNITION METHOD AND APPARATUS

(71) Applicants: NUCTECH COMPANY LIMITED, Beijing (CN); TSINGHUA UNIVERSITY, Beijing (CN)

(72) Inventors: Zhiqiang CHEN, Beijing (CN); Li ZHANG, Beijing (CN); Yunda SUN, Beijing (CN); Juan ZHENG, Beijing (CN); Lu WANG, Beijing (CN); Tao YANG, Beijing (CN); Dong LI, Beijing (CN)

(21) Appl. No.: 18/293,704

(22) PCT Filed: Jul. 8, 2022
(86) PCT No.: PCT/CN2022/104606

§ 371 Date: Jan. 30, 2024

(30) Foreign Application Priority Data
Aug. 27, 2021 (CN) 202110998653.3

(51) Int. Cl. G06V 10/84; G06T 3/40; G06T 11/00; G06V 10/44; G06V 10/48

(52) U.S. Cl. CPC G06V 10/84; G06T 3/40; G06T 11/006; G06V 10/457; G06V 10/48; G06T 2211/428; G06T 2211/441; G06V 2201/05; G06V 2201/07; G06V 2201/12

(57) ABSTRACT

A method and an apparatus of identifying at least one target object for a security inspection CT are provided. The method includes: performing a dimension reduction on three-dimensional CT data to generate a plurality of two-dimensional dimension-reduced views (S10); performing a target identification on a plurality of two-dimensional views to obtain a set of two-dimensional semantic descriptions of the at least one target object, where the plurality of two-dimensional views include the plurality of two-dimensional dimension-reduced views (S20); and performing a dimension increase on the set of two-dimensional semantic descriptions to obtain a three-dimensional recognition result of the at least one target object (S30).

### CROSS-REFERENCE TO RELATED APPLICATION(S)

The present disclosure corresponds to PCT Application No. PCT/CN2022/104606, which claims priority to Chinese patent Application No. 202110998653.3 filed on Aug. 27, 2021, the contents of which are incorporated herein by reference in their entireties.

### TECHNICAL FIELD

The present disclosure relates to a field of security inspection computed tomography (CT), and in particular to a method and an apparatus of identifying at least one target object for a security inspection CT.

### BACKGROUND

At present, in a field of security inspection, CT devices are often used to identify target objects such as prohibited items. When identifying a target object using a security inspection CT device, traditional technologies mainly include: obtaining a three-dimensional tomographic image containing a material attribute information by using a CT reconstruction technology, dividing the three-dimensional image into several suspected objects, and performing statistics and classification of material attributes on the suspected object.

Although the above-mentioned traditional technologies may have good performance in identifying prohibited items with strong separability in material properties such as explosives and drugs, they exhibit obvious limitations in identifying target objects with strong three-dimensional shape features and complex material composition and physical properties.

In order to solve such limitations, Patent Document 1 proposes a method and an apparatus for CT detection, which may separately identify a three-dimensional tomographic image and a two-dimensional image of an object, then obtain a recognition result of explosives through the former, and obtain a recognition result of other prohibited items through the latter.
Patent document 1: CN 109975335A

### SUMMARY

The present disclosure proposes a method and an apparatus of identifying at least one target object for a security inspection CT, which may improve a recognition effect on a three-dimensional shaped target object.

Embodiments of the present disclosure provide a method of identifying at least one target object for a security inspection CT, including: performing a dimension reduction on three-dimensional CT data to generate a plurality of two-dimensional dimension-reduced views: performing a target identification on a plurality of two-dimensional views to obtain a set of two-dimensional semantic descriptions of the at least one target object, where the plurality of two-dimensional views include the plurality of two-dimensional dimension-reduced views: and performing a dimension increase on the set of two-dimensional semantic descriptions to obtain a three-dimensional recognition result of the at least one target object.

In the above-mentioned method of identifying the at least one target object for the security inspection CT, the performing a dimension increase on the set of two-dimensional semantic descriptions to obtain a three-dimensional recognition result of the at least one target object includes: mapping the set of two-dimensional semantic descriptions to a three-dimensional space by using a back-projection method, so as to obtain a three-dimensional probability map; and performing a feature extraction on the three-dimensional probability map to obtain the three-dimensional recognition result of the at least one target object.

In the above-mentioned method of identifying the at least one target object for the security inspection CT, the mapping the set of two-dimensional semantic descriptions to a three-dimensional space by using a back-projection method so as to obtain a three-dimensional probability map includes: mapping the set of two-dimensional semantic descriptions to the three-dimensional space by voxel driving or pixel driving so as to obtain a semantic feature matrix, and compressing the semantic feature matrix into the three-dimensional probability map.

In the above-mentioned method of identifying the at least one target object for the security inspection CT, the voxel driving includes: mapping each voxel in the three-dimensional CT data to a pixel in each two-dimensional view, querying and accumulating a two-dimensional semantic description information corresponding to the pixel, and generating the semantic feature matrix: and the pixel driving includes: mapping each pixel in the two-dimensional view to a straight line in the three-dimensional CT data, traversing each pixel in each two-dimensional view or each pixel in a region of interest, propagating a two-dimensional semantic description information corresponding to the pixel into the three-dimensional space along the straight line, and generating the semantic feature matrix, where the region of interest is given by the set of two-dimensional semantic descriptions.

In the above-mentioned method of identifying the at least one target object for the security inspection CT, in the voxel driving or the pixel driving, a correspondence relationship between the voxel and the pixel is obtained by a mapping function or a lookup table.

In the above-mentioned method of identifying the at least one target object for the security inspection CT, the performing a feature extraction on the three-dimensional probability map to obtain the three-dimensional recognition result of the at least one target object includes: performing the feature extraction on the three-dimensional probability map by using at least one or a combination of an image processing method, a classic machine learning method, or a deep learning method, so as to obtain a set of three-dimensional image semantic descriptions as the three-dimensional recognition result.

In the above-mentioned method of identifying the at least one target object for the security inspection CT, the performing a feature extraction on the three-dimensional probability map to obtain the three-dimensional recognition result of the at least one target object includes: performing a binarization on the three-dimensional probability map to obtain a three-dimensional binary map: performing a connected component analysis on the three-dimensional binary map to obtain at least one connected component: and generating the set of three-dimensional image semantic descriptions for the at least one connected component.

In the above-mentioned method of identifying the at least one target object for the security inspection CT, the performing a connected component analysis includes: performing a connected component labeling on the three-dimensional binary map, and performing a mask operation on each labeled region to obtain the at least one connected component.

In the above-mentioned method of identifying the at least one target object for the security inspection CT, the generating the set of three-dimensional image semantic descriptions for the at least one connected component includes: extracting all probability values for each connected component, performing a principal component analysis to obtain an analysis set, and statistically generating the set of three-dimensional image semantic descriptions by using the analysis set as a valid voxel volume of object.

In the above-mentioned method of identifying the at least one target object for the security inspection CT, the set of three-dimensional image semantic descriptions includes a category information and/or a confidence level, in units of one or more of voxels, three-dimensional volumes of interest, or three-dimensional CT images: or the set of three-dimensional image semantic descriptions includes at least one of a category information, a position information of the at least one target object, or a confidence level, in units of three-dimensional volumes of interest and/or three-dimensional CT images.

In the above-mentioned method of identifying the at least one target object for the security inspection CT, the position information includes a three-dimensional bounding box.

In the above-mentioned method of identifying the at least one target object for the security inspection CT, the set of two-dimensional semantic descriptions includes a category information and/or a confidence level, in units of one or more of pixels, regions of interest, or two-dimensional images: or the set of two-dimensional semantic descriptions includes at least one of a category information, a confidence level, or a position information of the at least one target object, in units of regions of interest and/or two-dimensional images.

In the above-mentioned method of identifying the at least one target object for the security inspection CT, the performing a target identification on each of the plurality of two-dimensional views includes: performing the target identification for two-dimensional images by using at least one or a combination of an image processing method, a classic machine learning method, or a deep learning method.

In the above-mentioned method of identifying the at least one target object for the security inspection CT, the performing a dimension reduction on three-dimensional CT data to generate a plurality of two-dimensional dimension-reduced views includes: setting a plurality of directions for the three-dimensional CT data; and projecting or rendering according to the plurality of directions.

In the above-mentioned method of identifying the at least one target object for the security inspection CT, the plurality of directions are arbitrary directions and are not limited to a direction orthogonal to a traveling direction of an object during a detection process.

In the above-mentioned method of identifying the at least one target object for the security inspection CT, the plurality of two-dimensional views further include a two-dimensional DR image, and the two-dimensional DR image is acquired by a DR imaging device.

In the above-mentioned method of identifying the at least one target object for the security inspection CT, the three-dimensional recognition result is projected onto the two-dimensional DR image and output as a recognition result of the two-dimensional DR image.

Embodiments of the present disclosure further provide an apparatus of identifying at least one target object for a security inspection CT, including: a dimension reduction module configured to perform a dimension reduction on three-dimensional CT data to generate a plurality of two-dimensional dimension-reduced views: a two-dimensional identification module configured to perform a target identification on a plurality of two-dimensional views to obtain a set of two-dimensional semantic descriptions of the at least one target object, where the plurality of two-dimensional views include the plurality of two-dimensional dimension-reduced views; and a dimension increase module configured to perform a dimension increase on the set of two-dimensional semantic descriptions to obtain a three-dimensional recognition result of the at least one target object.

Embodiments of the present disclosure further provide a non-transitory machine-readable storage medium having a program thereon, where the program, when executed by a processor, causes a computer to: perform a dimension reduction on three-dimensional CT data to generate a plurality of two-dimensional dimension-reduced views: perform a target identification on a plurality of two-dimensional views to obtain a set of two-dimensional semantic descriptions of the at least one target object, where the plurality of two-dimensional views include the plurality of two-dimensional dimension-reduced views; and perform a dimension increase on the set of two-dimensional semantic descriptions to obtain a three-dimensional recognition result of the at least one target object.

### BRIEF DESCRIPTION OF THE DRAWINGS

FIG. 1 shows a flowchart of a method of identifying at least one target object for a security inspection CT according to a first embodiment:

FIG. 2 shows a flowchart of an example of a dimension reduction;

FIG. 3 shows a flowchart of an example of a dimension increase;

FIG. 4 shows a flowchart of an example of a three-dimensional feature extraction:

FIG. 5 shows a flowchart of a method of identifying at least one target object for a security inspection CT according to a second embodiment:

FIG. 6 shows a schematic diagram of an example of an apparatus of identifying at least one target object for a security inspection CT according to a third embodiment: and

FIG. 7 shows a schematic diagram of another example of an apparatus of identifying at least one target object for a security inspection CT according to the third embodiment.

### DETAILED DESCRIPTION OF EMBODIMENTS

Although Patent Document 1 attempts to improve the above limitations, the inventors of the present disclosure found through research that Patent Document 1 still has the following technical problems:
(1) A projection is only performed in a direction orthogonal to a traveling direction (Z direction) of an object during a detection process. Under some placement postures of the object, a projection region may be too small and a shape information may be incompletely expressed, so that it is difficult to accurately identify a target object. In addition, the projection performed in this way may cause the object to be blocked by other objects, and then the shape information of the object may be lost, so that it is difficult to accurately identify the target object.
(2) In this method, although a two-dimensional projection image obtained from the three-dimensional tomographic image may be used to identify prohibited items other than explosives, the identification operation is only limited to a two-dimensional plane, and a recognition result in a three-dimensional space may not be obtained. Since an information content of the two-dimensional image is significantly lower than that of the three-dimensional data, the advantages of the security inspection CT device may not be fully utilized without an effective integration of the two-dimensional recognition result.

Exemplary embodiments of the present disclosure will be described in more detail below with reference to the accompanying drawings. Although exemplary embodiments of the present disclosure are shown in the accompanying drawings, it should be understood that the present disclosure may be implemented in various forms and should not be limited to embodiments set forth herein. Rather, these embodiments are provided for a clearer understanding of the present disclosure.

The terms “first”, “second”, etc. in the specification and claims of the present disclosure are used to distinguish similar objects, rather than describe a specific order or sequence. It should be understood that data used in this way are interchangeable under appropriate circumstances so that embodiments of the present disclosure described herein may be implemented in an order other than that illustrated or described. Furthermore, the terms “include” and “have” and any variations thereof are intended to cover non-exclusive inclusions, such as processes, methods, systems, products or devices that include a series of steps or units, not limited to those explicitly listed, but may include other steps or units not expressly listed. Herein, the same or similar reference numerals represent constitute elements having the same or similar functions.

### First Embodiment

As the first embodiment of the present disclosure, a method of identifying at least one target object for a security inspection CT is provided. FIG. 1 shows a flowchart of a method of identifying at least one target object for a security inspection CT according to the first embodiment. The method of identifying the at least one target object for the security inspection CT is applicable to a security inspection CT system, and may be performed, for example, in a security inspection CT device or in a server connected to the security inspection CT device.

As shown in FIG. 1, in step S10, a dimension reduction is performed. That is, a dimension reduction is performed on three-dimensional CT data to generate a plurality of two-dimensional dimension-reduced views.

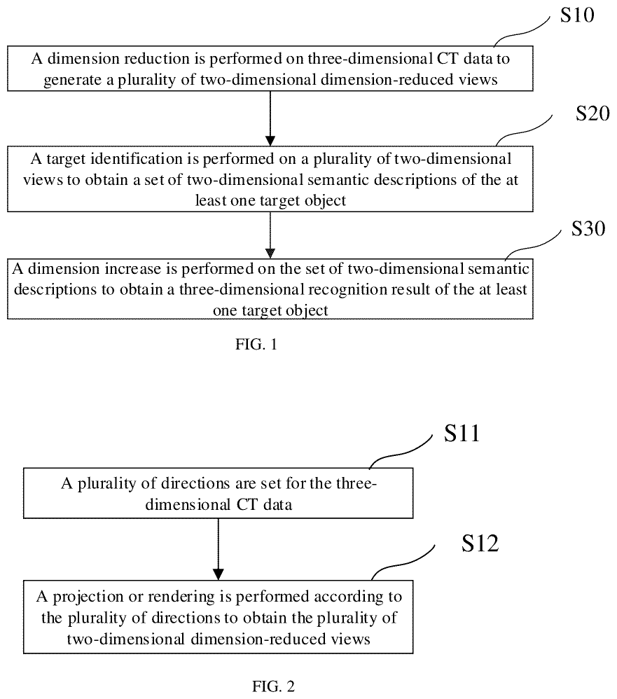

For example, as shown in FIG. 2, step S10 may include step S11 and step S12.

In step S11, a plurality of directions are set for the three-dimensional CT data. Here, the plurality of directions are arbitrary directions and are not limited to a specific direction such as a direction orthogonal to a traveling direction of an object during a detection process.

In addition, while setting the plurality of directions, or before and after setting the plurality of directions, optionally, it is possible to perform a preprocessing operation on three-dimensional volume data, such as filtering an invalid voxel and pre-calculating a geometric parameter required by projection or rendering, so that a subsequent processing speed may be improved.

In step S12, a projection or rendering is performed according to the plurality of directions to obtain the plurality of two-dimensional dimension-reduced views.

As an example, a ray casting may be performed based on a CT image slice sequence. From each pixel of the image, a ray may be emitted in a specific direction, and the ray passes through the entire image sequence. In this process, a sampling is performed on the image sequence to obtain an attribute or color information, and attribute or color values are accumulated according to a particular model until the ray passes through the entire image sequence. The finally obtained attribute or color value may be used as the dimensional-reduced two-dimensional view.

In the present disclosure, the two-dimensional dimension-reduced view is obtained by projecting in any direction, then it is possible to avoid that the dimension reduction is performed only in a specific direction, such as a direction orthogonal to the traveling direction of the object during the detection process. In this way, the following problems caused by performing the dimension reduction only in a specific direction may be solved: (1) under some placement postures of objects, an area of the object after dimension reduction is too small and a shape information is incompletely expressed, so that it is difficult to accurately identify the target object: (2) the shape information of the object is lost because the object is blocked by other objects, so that it is difficult to accurately identify the target object.

In step S20, a two-dimensional identification is performed. That is, a target identification is performed on a plurality of two-dimensional views to obtain a set of two-dimensional semantic descriptions of the at least one target object. Here, the plurality of two-dimensional views include the plurality of two-dimensional dimension-reduced views obtained in step S10 described above.

For example, at least one or a combination of an image processing method for two-dimensional images, a classic machine learning method, or a deep learning method may be used as a method of identifying at least one target object in a two-dimensional view.

For example, a two-dimensional view may be input into a neural network model and a set of two-dimensional semantic descriptions may be output.

For example, a deep learning-based target detection neural network may be used to detect a two-dimensional position of the at least one target object. A convolutional neural network used in a target detection task is a typical structure of deep learning in a computer vision task. Such convolutional neural network has characteristics of local connection, weight sharing, and spatial resampling, etc. These characteristics give the convolutional neural network a certain degree of translation and scaling invariance. Here, the set of two-dimensional semantic descriptions includes a category information and/or a confidence level, in units of one or more of pixels, regions of interest, or two-dimensional images. Alternatively, the set of two-dimensional semantic descriptions may include at least one of a category information, a confidence level, or a position information of the at least one target object, in units of regions of interest and/or two-dimensional images. The category information indicates a category to which the at least one target object belongs, such as guns, knives, etc. The position information may contain center coordinates, a bounding box, etc. The confidence level represents a possibility of an existence of the at least one target object, and may be a normalized scalar or vector.

In other words, the set of two-dimensional semantic descriptions includes at least one information selected from: a category information of the target object to which a pixel belongs, a confidence level, etc.; a category information of the at least one target object contained in a region of interest, a position information of the at least one target object, a confidence level, etc.: or a category information of the at least one target object contained in a two-dimensional image, a position information of the at least one target object, a confidence level, etc. The at least one information may be information contained in one group, or may be information contained in different groups.

In addition to the category information, the confidence level and the position information, the set of descriptions for two-dimensional semantic information may further include a posture of the at least one target object, a number of the at least one target object, and other semantic information.

The method of identifying the at least one target object for the two-dimensional view of the present disclosure is not particularly limited, as long as it is a method that may obtain the above-mentioned set of two-dimensional semantic descriptions based on the two-dimensional view.

As mentioned above, in the present disclosure, the two-dimensional recognition result of the at least one target object is expressed in the form of a set of two-dimensional semantic descriptions. Such set of two-dimensional semantic descriptions is input in step S30 and the dimensions are increased to three, so that the two-dimensional recognition results may be integrated into a three-dimensional result. In addition, the set of two-dimensional semantic descriptions is flexible, and may contain abundant information.

In step S30, a dimension increase is performed. That is, a dimension increase is performed on the set of two-dimensional semantic descriptions to obtain a three-dimensional recognition result of the at least one target object.

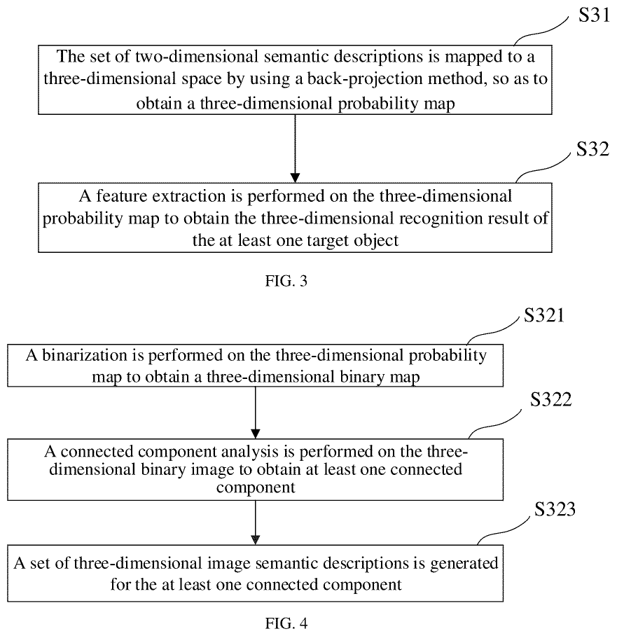

For example, as shown in FIG. 3, step S30 may include step S31 and step S32.

In step S31, the set of two-dimensional semantic descriptions is mapped to a three-dimensional space by using a back-projection method, so as to obtain a three-dimensional probability map. The back-projection may be considered as a reverse process of projection.

Optionally, the back-projection process may be implemented by voxel driving or pixel driving method. For example, it is possible to obtain a semantic feature matrix by voxel driving or pixel driving, and compress the semantic feature matrix into a three-dimensional probability map.

Here, the voxel driving includes: mapping each voxel in the three-dimensional CT data to a pixel in each two-dimensional view, querying and accumulating the two-dimensional semantic description information corresponding to the pixel, and generating a semantic feature matrix.

For a correspondence relationship between the voxel and the pixel, a mapping function or a lookup table may be established to increase a computing speed.

As mentioned above, according to the voxel driving, each voxel in the three-dimensional CT data is traversed to obtain the semantic feature matrix thereof sequentially, and finally the semantic feature matrix is compressed to obtain the three-dimensional probability map.

In the voxel driving, parallel operations may be performed on each voxel, so that a computing speed is fast, and a real-time performance of the security inspection may be improved.

The pixel driving includes: mapping each pixel in the two-dimensional view to a straight line in the three-dimensional CT data, traversing each pixel in each two-dimensional view or each pixel in the region of interest, propagating the two-dimensional semantic description information corresponding to the pixel into the three-dimensional space along the straight line, and generating a semantic feature matrix. The region of interest is given by the set of two-dimensional semantic descriptions. The correspondence relationship between the voxel and the pixel may also be obtained through a mapping function or a lookup table.

As mentioned above, according to the pixel driving, for each pixel in the plurality of two-dimensional views, the semantic feature matrix thereof is obtained sequentially, and finally the semantic feature matrix is compressed to obtain the three-dimensional probability map.

In the pixel driving, it is also possible to perform parallel operations on pixels, which is also helpful to increase the computing speed and improve the real-time performance of the security inspection.

According to the above description of voxel driving and pixel driving, the semantic feature matrix is generated from the two-dimensional semantic description information according to a spatial correspondence thereof, and it is a matrix obtained through digitization and intensification based on the two-dimensional semantic description information. For example, for the category information in the set of two-dimensional semantic descriptions, the semantic feature matrix may be obtained separately according to the category of each target object. For example, it may be assumed that the corresponding value in the semantic feature matrix is 1 when the target object belongs to the category, and the corresponding value in the semantic feature matrix is 0 when the target object does not belong to the category. In addition, for other semantic information in the set of two-dimensional semantic descriptions, the semantic feature matrix may also be obtained in a similar way.

Typical methods for compressing the semantic feature matrix include weighted average, principal component analysis, etc. In this case, the input is the semantic feature matrix, and the output is the probability map.

As an example, assuming there are two two-dimensional views and two sets of two-dimensional semantic descriptions, and the semantic information on a pixel (or region of interest or two-dimensional image) is numerically represented as 1 or 0, then the two sets of two-dimensional semantic descriptions may be mapped to the three-dimensional space by using a back-projection method, so as to generate the semantic feature matrix corresponding to the three-dimensional space. The values in the matrix are vectors composed of 0 or 1. A probability map value of the voxel in the corresponding three-dimensional space may be calculated using a weighted average method. For example, if the semantic feature matrix value of a voxel is v=[0,1], the probability map value of the voxel is 0.5 in a case that the weights are the same. When compressing the semantic feature matrix corresponding to all target object categories, the dimension of the output probability map value is determined by the number of target object categories. The method of obtaining the probability map value explained here is just an example, and the probability map value may also be obtained in other ways. For example, the weights may be different, and the semantic feature matrix values may be weighted with different weights to obtain the probability map value.

As another example, one or more vectors in the three-dimensional semantic feature matrix may be used as input variable(s) in a principal component analysis. A principal component analysis may be performed on such input variable to obtain an output variable as a principal component. The output variable may be normalized as a probability map value for the corresponding voxel.

By using the above-mentioned calculation method, it may not only ensure the real-time performance of the calculation, but also effectively integrate the two-dimensional recognition results to improve the final recognition effect.

In step S32, a feature extraction is performed on the three-dimensional probability map to obtain the three-dimensional recognition result of the at least one target object.

For example, for the three-dimensional probability map, the feature extraction is performed using at least one or a combination of an image processing method, a classic machine learning method, or a deep learning method, so as to obtain a set of three-dimensional image semantic descriptions as the three-dimensional recognition result.

As an example, the three-dimensional probability map is input into a deep learning model, and a three-dimensional recognition result such as a confidence level and a three-dimensional bounding box is output. The deep learning model used here may adopt technologies such as a classification neural network or an object detection network with a few layers. By using such technologies, the information content contained in the original three-dimensional CT data may be effectively simplified and abstracted through the above steps, and is closer to an ultimate goal of identifying prohibited items, then it is possible to quickly and accurately extract the set of three-dimensional semantic descriptions using a simple feature extraction method.

Here, the set of three-dimensional image semantic descriptions includes a category information and/or a confidence level, in units of one or more of voxels, three-dimensional volumes of interest, or three-dimensional CT images. Alternatively, the set of three-dimensional image semantic descriptions includes at least one of a category information, a position information of the at least one target object, or a confidence level, in units of three-dimensional volumes of interest and/or three-dimensional CT images. The position information of the at least one target object in the three-dimensional CT image may include a three-dimensional bounding box.

In other words, the set of three-dimensional image semantic descriptions includes at least one selected from: a category information of a target object to which a voxel belongs, a confidence level, etc.; a category information of at least one target object contained in a three-dimensional volume of interest (VOI), a position information of the at least one target object, a confidence level, etc.; a category information of at least one target object contained in a three-dimensional CT image, a position information of the at least one target object, a confidence level, etc. The at least one information may be information contained in one group, or may be information contained in different groups.

Since the set of three-dimensional image semantic descriptions is generated from the three-dimensional probability map generated based on the set of two-dimensional semantic descriptions, there is consistency or mutual conversion between types of the semantic information contained in the set of three-dimensional image semantic descriptions and types of the semantic information contained in the set of two-dimensional semantic descriptions.

In the present disclosure, through the above-mentioned dimension increase, a dimension increase is performed on the set of two-dimensional semantic descriptions to obtain a three-dimensional recognition result of the at least one target object, so that the problem of significantly reduced information content caused when the two-dimensional identification is performed only by dimension reduction is solved. Then, a loss of information content may be reduced while the two-dimensional identification is used, and both the real-time performance and the accuracy of the security inspection may be considered.

As another example of step S32, for example, an image processing method may be used. As shown in FIG. 4, step S32 may include steps S321 to S323.

In step S321, a binarization is performed on the three-dimensional probability map to obtain a three-dimensional binary map.

In step S322, a connected component analysis is performed on the three-dimensional binary image to obtain at least one connected component.

As an example, a connected component labeling may be performed on the three-dimensional binary image, and a mask operation may be performed on each labeled region to obtain at least one connected component.

In step S323, a set of three-dimensional image semantic descriptions is generated for the at least one connected component.

Then, the set of three-dimensional image semantic descriptions may include a three-dimensional bounding box. The three-dimensional bounding box may give a spatial boundary of the target object in the three-dimensional image, and a position, a range, a posture, a shape, etc. of the target object may be shown more intuitively, which is helpful for security personnel to accurately determine whether the target object is a dangerous item.

As an example, all probability values for each connected component may be extracted, a principal component analysis may be performed to obtain an analysis set, and the analysis set may be used as a valid voxel volume of object. A set of three-dimensional image semantic descriptions may be statistically generated for the valid voxel volume. In this way, the accuracy of three-dimensional identification may be further improved.

In the first embodiment, a dimension reduction is performed on three-dimensional CT data to generate a plurality of two-dimensional dimension-reduced views, a target recognition is performed using a plurality of two-dimensional views including the plurality of two-dimensional dimension-reduced views to obtain a set of two-dimensional semantic descriptions, and then a dimension increase is performed on the set of two-dimensional semantic descriptions to obtain a three-dimensional recognition result. That is, the dimensions are firstly reduced from three dimensions to two dimensions for identification and then increased to generate a three-dimensional result. In this way, it is possible to effectively recognize a target object with complex material composition and physical properties and having shape features through a two-dimensional identification, and also possible to effectively integrate two-dimensional recognition results to provide a three-dimensional recognition result with a rich information content. In this way, a recognition effect of the target object may be improved, and requirements for real-time performance of a security inspection may be met.

### Second Embodiment

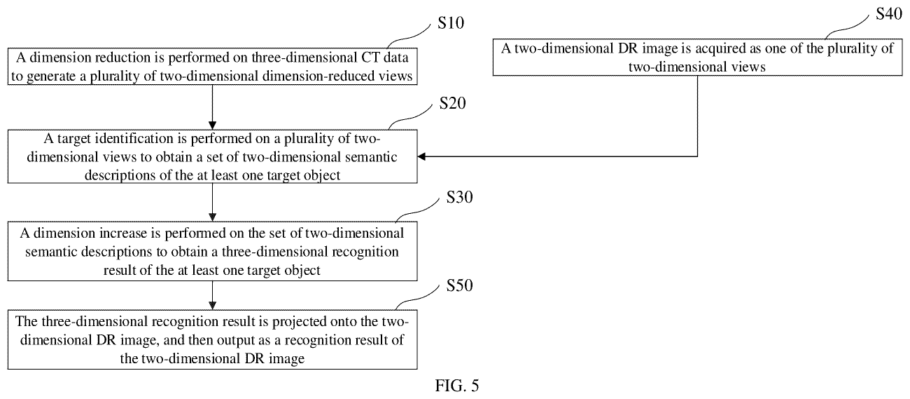

As the second embodiment of the present disclosure, another method of identifying at least one target object for a security inspection CT is provided. FIG. 5 shows a flowchart of the method of identifying the at least one target object for the security inspection CT according to the first embodiment.

The second embodiment differs from the first embodiment in that: in the second embodiment, not only the two-dimensional dimension-reduced image generated from the three-dimensional CT data is used, but also two-dimensional digital radiography (DR) data is used for identifying the at least one target object.

For example, in step S20, the plurality of two-dimensional views further include a two-dimensional DR image, and the target identification is also performed on the two-dimensional DR image to obtain a set of two-dimensional semantic descriptions of the at least one target object. Here, the two-dimensional DR image is acquired by a DR imaging device provided independently from the security CT device. The two-dimensional DR image is an image of the same security inspection object as the three-dimensional CT data.

In the second embodiment, as shown in FIG. 5, step S40 may be performed before step S20. In step S40, a two-dimensional DR image is acquired from the DR imaging device and is used as one of the plurality of two-dimensional views. Step S40 may be performed in parallel with step S10.

In this case, in step S30, the dimension increase is performed not only on the set of two-dimensional semantic descriptions of the two-dimensional dimension-reduced image, but also on the set of two-dimensional semantic descriptions of the two-dimensional DR image, so as to obtain a three-dimensional recognition result.

The two-dimensional DR image is a two-dimensional image with different principles and properties from the two-dimensional dimension-reduced image generated by performing a dimension reduction on the three-dimensional CT data. By using such two-dimensional DR image for the target identification, it is possible to increase the information content used for identification, and the accuracy of identification may be improved.

In the second embodiment, as shown in FIG. 5, step S50 may be optionally performed after step S30. In step S50, the three-dimensional recognition result generated in step S30 is projected onto the two-dimensional DR image, and then a recognition result of the two-dimensional DR image is output.

Due to work habits and requirements, some security personnel want to confirm the recognition result in the two-dimensional DR image. However, if the recognition result of the two-dimensional DR image is used directly, when the target object in the DR image is seriously blocked or has a special placement posture, the information of the target object may be incomplete, which affects the recognition accuracy. A three-dimensional recognition result is obtained by effectively integrating the semantic information of several two-dimensional views, so that it is more accurate and reliable. Therefore, by projecting the three-dimensional recognition result onto the two-dimensional DR image as the recognition result for output, the accuracy of the recognition result may be improved while meeting the work requirements of security personnel to confirm the recognition result through the two-dimensional DR image.

In addition, the result of step S30 and the result of step S50 may be output simultaneously.

In this case, the three-dimensional recognition result and the recognition result in the two-dimensional DR image may be compared and verified with each other, which is helpful to the security personnel to more accurately determine whether the target object is a dangerous item.

### Third Embodiment

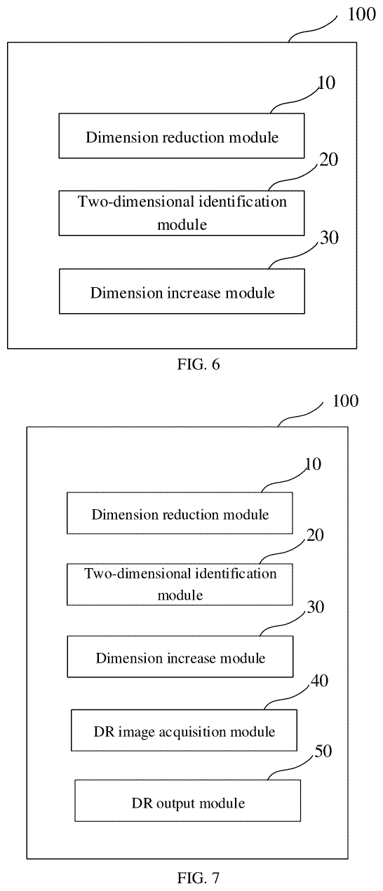

As the third embodiment of the present disclosure, an apparatus of identifying at least one target object for a security inspection CT is provided. FIG. 6 shows a schematic diagram of the apparatus of identifying the at least one target object for the security inspection CT according to the first embodiment.

As shown in FIG. 6, an apparatus 100 of identifying at least one target object for a security inspection CT in this embodiment includes a dimension reduction module 10, a two-dimensional identification module 20, and a dimension increase module 30.

The dimension reduction module 10 is used to perform a dimension reduction on three-dimensional CT data to generate a plurality of two-dimensional dimension-reduced views. That is, the dimension reduction module 10 may perform step S10 in the first and second embodiments described above.

The two-dimensional identification module 20 is used to perform a target identification on a plurality of two-dimensional views to obtain a set of two-dimensional semantic descriptions of the at least one target object. Here, the plurality of two-dimensional views include the plurality of two-dimensional dimension-reduced views. That is, the two-dimensional identification module 20 may perform step S20 in the first and second embodiments described above.

The dimension increase module 30 is used to perform a dimension increase on the set of two-dimensional semantic descriptions to obtain a three-dimensional recognition result of the at least one target object. That is, the dimension increase module 30 may perform step S30 in the first and second embodiments described above.

For the processing of the dimension reduction module 10, the two-dimensional identification module 20 and the dimension increase module 30, reference may be made to the first and second embodiments described above, and details will not be repeated here.

In addition, as shown in FIG. 7, the apparatus 100 of identifying the at least one target object for the security inspection CT may further include a DR image acquisition module 40. The DR image acquisition module 40 is used to acquire a two-dimensional DR image from a DR imaging device as one of the plurality of two-dimensional views. That is, the DR image acquisition module 40 may perform step S40 in the second embodiment.

The apparatus 100 of identifying the at least one target object for the security inspection CT may further include a DR output module 50. The DR output module 50 is used to project the three-dimensional recognition result generated by the dimension increase module 30 to the two-dimensional DR image, and then a recognition result of the two-dimensional DR image is output. That is, the DR output module 50 may perform step S50 in the second embodiment.

In the present disclosure, the apparatus 100 of identifying the at least one target object for the security inspection CT may be implemented in a form of hardware, or implemented as a software module running on one or more processors, or implemented in a combination thereof.

For example, the apparatus 100 of identifying the at least one target object for the security inspection CT may be implemented in a combination of software and hardware by any suitable electronic device such as a desktop computer, a tablet computer, a smart phone, a server, etc. provided with a processor. For example, the apparatus 100 of identifying the at least one target object for the security inspection CT may be a control computer of a security inspection CT system, or a server connected to a security inspection CT scanning device in the security inspection CT system, etc.

In addition, the apparatus 100 of identifying the at least one target object for the security inspection CT may be implemented as a software module on any suitable electronic device such as a desktop computer, a tablet computer, a smart phone, a server, etc., e.g., a software module installed on a control computer of the security inspection CT system, or a software module installed on a server connected to the security inspection CT scanning device in the security inspection CT system.

The processor of the apparatus 100 of identifying the at least one target object for the security inspection CT may perform the method of identifying the at least one target object for the security inspection CT described above.

The apparatus 100 of identifying the at least one target object for the security inspection CT may further include a memory (not shown), a communication module (not shown), and the like.

The memory of the apparatus 100 of identifying the at least one target object for the security inspection CT may store steps for executing the method of identifying the at least one target object for the security inspection CT described above, and data related to target identification for the security inspection CT, etc. The memory may be, for example, ROM (read Only Memory image), RAM (Random Access Memory), etc. The memory has a storage space for program codes for executing any step in the above-mentioned method of identifying the at least one target object for the security inspection CT. When these program codes are read and executed by the processor, the above-mentioned method of identifying the at least one target object for the security inspection CT may be performed. These program codes may be read from or written into one or more computer program products. These computer program products include program code carriers such as hard disks, compact disks (CDs), memory cards or floppy disks. Such computer program products are generally portable or fixed storage units. The program codes for performing any of the steps in the above-mentioned methods may also be downloaded through a network. The program codes may be, for example, compressed in a suitable form.

The communication module in the apparatus 100 of identifying the at least one target object for the security inspection CT may support an establishment of a direct (e.g., wired) communication channel or a wireless communication channel between the apparatus 100 of identifying the at least one target object for the security inspection CT and an external electronic device, and may perform communication via the established communication channel. For example, the communication module may receive the three-dimensional CT data, etc. from the CT scanning device via the network.

In addition, the apparatus 100 of identifying the at least one target object for the security inspection CT may further include an output part such as a display, a microphone, and a speaker, etc. to output the target recognition result.

The above-mentioned apparatus 100 of identifying the at least one target object for the security inspection CT may be implemented to achieve the same effects as the first and second embodiments described above.

Although embodiments and specific examples of the present disclosure have been described above with reference to the accompanying drawings, those skilled in the art may make various modifications and variations without departing from the spirit and scope of the present disclosure. Such modifications and variations fall within the scope defined by the claims.

1. A method of identifying at least one target object for a security inspection CT, comprising:
performing a dimension reduction on three-dimensional CT data to generate a plurality of two-dimensional dimension-reduced views;
performing a target identification on a plurality of two-dimensional views to obtain a set of two-dimensional semantic descriptions of the at least one target object, wherein the plurality of two-dimensional views comprise the plurality of two-dimensional dimension-reduced views; and
performing a dimension increase on the set of two-dimensional semantic descriptions to obtain a three-dimensional recognition result of the at least one target object.

2. The method of identifying the at least one target object for the security inspection CT according to claim 1, wherein the performing a dimension increase on the set of two-dimensional semantic descriptions to obtain a three-dimensional recognition result of the at least one target object comprises:
mapping the set of two-dimensional semantic descriptions to a three-dimensional space by using a back-projection method, so as to obtain a three-dimensional probability map; and
performing a feature extraction on the three-dimensional probability map to obtain the three-dimensional recognition result of the at least one target object.

3. The method of identifying the at least one target object for the security inspection CT according to claim 2, wherein the mapping the set of two-dimensional semantic descriptions to a three-dimensional space by using a back-projection method so as to obtain a three-dimensional probability map comprises:
mapping the set of two-dimensional semantic descriptions to the three-dimensional space by voxel driving or pixel driving so as to obtain a semantic feature matrix, and compressing the semantic feature matrix into the three-dimensional probability map.

4. The method of identifying the at least one target object for the security inspection CT according to claim 3, wherein the voxel driving comprises:
mapping each voxel in the three-dimensional CT data to a pixel in each two-dimensional view, querying and accumulating a two-dimensional semantic description information corresponding to the pixel, and generating the semantic feature matrix; and
wherein the pixel driving comprises:
mapping each pixel in the two-dimensional view to a straight line in the three-dimensional CT data, traversing each pixel in each two-dimensional view or each pixel in a region of interest, propagating a two-dimensional semantic description information corresponding to the pixel into the three-dimensional space along the straight line, and generating the semantic feature matrix, wherein the region of interest is given by the set of two-dimensional semantic descriptions.

5. The method of identifying the at least one target object for the security inspection CT according to claim 4, wherein in the voxel driving or the pixel driving, a correspondence relationship between the voxel and the pixel is obtained by a mapping function or a lookup table.

6. The method of identifying the at least one target object for the security inspection CT according to claim 2, wherein the performing a feature extraction on the three-dimensional probability map to obtain the three-dimensional recognition result of the at least one target object comprises:
performing the feature extraction on the three-dimensional probability map by using at least one or a combination of an image processing method, a classic machine learning method, or a deep learning method, so as to obtain a set of three-dimensional image semantic descriptions as the three-dimensional recognition result.

7. The method of identifying the at least one target object for the security inspection CT according to claim 6, wherein
a binarization is performed on the three-dimensional probability map to obtain a three-dimensional binary map;
a connected component analysis is performed on the three-dimensional binary map to obtain at least one connected component; and
the set of three-dimensional image semantic descriptions is generated for the at least one connected component.

8. The method of identifying the at least one target object for the security inspection CT according to claim 7, wherein performing the connected component analysis comprises:
performing a connected component labeling on the three-dimensional binary map, and performing a mask operation on each labeled region to obtain the at least one connected component.

9. The method of identifying the at least one target object for the security inspection CT according to claim 7, wherein the generating the set of three-dimensional image semantic descriptions for the at least one connected component comprises:
extracting all probability values for each connected component, performing a principal component analysis to obtain an analysis set, and statistically generating a three-dimensional image semantic description by using the analysis set.

10. The method of identifying the at least one target object for the security inspection CT according to claim 6, wherein the set of three-dimensional image semantic descriptions comprises a category information and/or a confidence level, in units of one or more of voxels, three-dimensional volumes of interest, or three-dimensional CT images; or
the set of three-dimensional image semantic descriptions comprises at least one of a category information, a position information of the at least one target object, or a confidence level, in units of three-dimensional volumes of interest and/or three-dimensional CT images.

11. The method of identifying the at least one target object for the security inspection CT according to claim 10, wherein the position information comprises a three-dimensional bounding box.

12. The method of identifying the at least one target object for the security inspection CT according to claim 1, wherein the set of two-dimensional semantic descriptions comprises a category information and/or a confidence level, in units of one or more of pixels, regions of interest, or two-dimensional images; or
the set of two-dimensional semantic descriptions comprises at least one of a category information, a confidence level, or a position information of the at least one target object, in units of regions of interest and/or two-dimensional images.

13. The method of identifying the at least one target object for the security inspection CT according to claim 1, wherein performing the target identification on each of the plurality of two-dimensional views comprises:
performing the target identification for two-dimensional images by using at least one or a combination of an image processing method, a classic machine learning method, or a deep learning method.

14. The method of identifying the at least one target object for the security inspection CT according to claim 1, wherein the performing a dimension reduction on three-dimensional CT data to generate a plurality of two-dimensional dimension-reduced views comprises:
setting a plurality of directions for the three-dimensional CT data; and
projecting or rendering according to the plurality of directions.

15. The method of identifying the at least one target object for the security inspection CT according to claim 14, wherein the plurality of directions are arbitrary directions and are not limited to a direction orthogonal to a traveling direction of an object during a detection process.

16. The method of identifying the at least one target object for the security inspection CT according to claim 1, wherein the plurality of two-dimensional views further comprise a two-dimensional DR image, and the two-dimensional DR image is acquired by a DR imaging device.

17. The method of identifying the at least one target object for the security inspection CT according to claim 16, wherein the three-dimensional recognition result is projected onto the two-dimensional DR image and output as a recognition result of the two-dimensional DR image.

18. An apparatus of identifying at least one target object for a security inspection CT, the apparatus comprising a processor and a non-transitory machine-readable storage medium storing a program that when executed by the processor, causes the processor to:
perform a dimension reduction on three-dimensional CT data to generate a plurality of two-dimensional dimension-reduced views;
perform a target identification on a plurality of two-dimensional views to obtain a set of two-dimensional semantic descriptions of the at least one target object, wherein the plurality of two-dimensional views comprise the plurality of two-dimensional dimension-reduced views; and
perform a dimension increase on the set of two-dimensional semantic descriptions to obtain a three-dimensional recognition result of the at least one target object.

19. A non-transitory machine-readable storage medium having a program thereon, wherein the program, when executed by a processor, causes a computer to:
perform a dimension reduction on three-dimensional CT data to generate a plurality of two-dimensional dimension-reduced views;
perform a target identification on a plurality of two-dimensional views to obtain a set of two-dimensional semantic descriptions of the at least one target object, wherein the plurality of two-dimensional views comprise the plurality of two-dimensional dimension-reduced views; and
perform a dimension increase on the set of two-dimensional semantic descriptions to obtain a three-dimensional recognition result of the at least one target object.
